(19) United States
(12) Patent Application Publication
(10) Pub. No.: US 2005/0239954 A1
(43) Pub. Date: Oct. 27, 2005

(54) Hybrid dispersions made of polyadducts and radical polymers

(75) Inventors: Ulrike Licht, Mannheim (DE); Susanne Deutrich, Munster (DE); Markus Antonietti, Bergholz-Rehbrucke (DE); Kathrina Landfester, Berlin (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: MAX-PLANCK-GESELLSCHAFT, MUENCHEN (DE)

(21) Appl. No.: 10/525,941

(22) PCT Filed: Aug. 29, 2003
(86) PCT No.: PCT/EP03/09595

§ 371 Date: Feb. 28, 2005

(30) Foreign Application Priority Data
Sep. 4, 2002 (DE) 10241294.4

(51) Int. Cl. C08K 3/00

(52) U.S. Cl. 524/589

(57) ABSTRACT

Hybrid dispersions comprising polyadducts and free-radical addition polymers, obtainable by first emulsifying the constituent monomers of said polyadducts and polymers in water and then conducting the polyaddition to prepare the polyadducts and the free-radical addition polymerization to prepare the polymers, the respective monomers being emulsified in water before 40% of the monomers of which the polyadducts are composed have reacted to form such polyadducts.

The present invention relates to hybrid dispersions comprising polyadducts and free-radical addition polymers, obtainable by first emulsifying the constituent monomers of said polyadducts and polymers in water and then conducting the polyaddition to prepare the polyadducts and the free-radical addition polymerization to prepare the polymers, the respective monomers being emulsified in water before 40% of the monomers of which the polyadducts are composed have reacted to form such polyadducts.

The present invention further relates to a process for preparing the hybrid dispersions of the invention and also to their use as binders for coating compositions or impregnating compositions, in adhesives, varnishes, paints or paper coating slips or as binders for fiber webs.

Hybrid dispersions comprising, for example, polyurethane dispersions and free-radical addition polymers are already known in the art. Hybrid dispersions of this kind are commonly prepared by starting from a polyurethane dispersion stabilized by incorporated ionic or nonionic, water-soluble groups and then conducting a free-radical addition polymerization in the particles of said polyurethane dispersion. However, as a result of their complicated preparation process, in which first a polyurethane is produced, this polyurethane is then emulsified, and then addition polymerization is carried out in the presence of the secondary dispersion obtained by emulsification, these hybrid dispersions are very expensive. Moreover, they have a permanent hydrophilicity which makes polymer films obtained from them sensitive to water.

From the prior art it is also known that both free-radical addition polymers (WO-A 00/29451) and polyadducts (WO-A 00/29465) can be prepared in aqueous miniemulsions.

Furthermore, WO-A 01/44334 describes using polyurethanes in aqueous miniemulsions which comprise polyacrylates. However, systems of this kind have the drawback that they always require a multistage preparation process, in which first a polyadduct is prepared, this polyadduct is then emulsified, and in the presence of the emulsified polyadduct, finally, a free-radical miniemulsion addition polymerization is conducted. In such hybrid dispersions, moreover, the monomer phase is found to have an unfavorably heightened viscosity in the presence of the polyadducts, which give rise, inter alia, to a relatively wide particle size distribution and relatively large emulsion droplets when emulsion is carried out, for example, with ultrasound. Additionally, the choice of adducts is limited to linear, soluble materials; crosslinked polymers cannot be employed. Moreover, the yield of polyadducts is limited.

It is an object of the present invention to remedy the disadvantages depicted and to provide improved hybrid dispersions which possess a particle distribution which is not too wide, which are able to include a very large number of different adducts, which are also obtained in a relatively high yield, and which are obtainable by a relatively simple process.

We have found that this object is achieved by the hybrid dispersions defined at the outset. The present invention additionally extends to the process for preparing hybrid dispersions and to their use as binders, for coating compositions or impregnations inter alia.

The hybrid dispersions of the invention comprising polyadducts and free-radical addition polymers are obtainable by first emulsifying the constituent monomers of the said polyadducts and said polymers in water, i.e., introducing the respective monomers into an aqueous dispersion by means of customary emulsifiers.

This is followed by the actual polyaddition for preparing the polyadducts and the actual free-radical addition polymerization for preparing the polymers. Another feature of the hybrid dispersions of the invention is that the particular monomers required are emulsified in water before 40% of the monomers of which the polyadducts are composed have reacted to form such polyadducts. Preferably, the monomers required in each case to prepare the polyadducts and the polymers should already be emulsified in water before 30%, advisably 20%, more advisably 10%, in particular 5%, and with particular preference 1% of the monomers of which the polyadducts are composed have reacted to form such polyadducts.

Suitable polyadducts are all those polymers which can be obtained by a corresponding polyaddition reaction. They include polyurethanes, which are obtainable by reacting polyisocyanates with compounds containing isocyanate-reactive groups.

In the case of the polyurethanes, the ratio of their constituent monomers, i.e., essentially the polyisocyanates and the compounds containing isocyanate-reactive groups, is situated in a range such that the ratio of isocyanate groups (a) to isocyanate-reactive groups (b) is from 0.5:1 to 5:1, in particular from 0.8:1 to 3:1, preferably from 0.9:1 to 1.5:1, and with particular preference 1:1.

Suitable polyisocyanates preferably include the diisocyanates commonly used in polyurethane chemistry.

Mention may be made in particular of diisocyanates X(NCO)₂, where X is an aliphatic hydrocarbon radical having 4 to 12 carbon atoms, a cycloaliphatic or aromatic hydrocarbon radical having 6 to 15 carbon atoms or an araliphatic hydrocarbon radical having 7 to 15 carbon atoms. Examples of such diisocyanates are tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI) such as the trans/trans, the cis/cis and the cis/transisomer, and mixtures of these compounds. Sterically hindered diisocyanates are particularly advantageous in this context.

Further suitable polyisocyanates include nonane triisocyanate and lysine triisocyanate, and also the biurets of the common diisocyanates.

Significant mixtures of these diisocyanates include the mixtures of the respective structural isomers of diisocyanatotoluene and diisocyanatodiphenylmethane; particular suitability is possessed by the mixture of 80 mol % of 2,4-diisocyanatotoluene and 20 mol % of 2,6-diisocyanatotoluene. It is additionally possible to use the mixtures of aromatic isocyanates with aliphatic or cycloaliphatic isocyanates, the preferred ratio of aliphatic to aromatic isocyanates being from 4:1 to 1:4.

As compounds (a) it is also possible to use isocyanates which in addition to the free isocyanate groups carry further, blocked isocyanate groups, e.g., isocyanurate, biuret, urea, allophanate, uretdione or carbodiimide groups.

Examples of suitable isocyanate-reactive groups are hydroxyl, epoxy, thiol, and primary and secondary amino groups. Preference is given to using hydroxyl-containing compounds or monomers (b).

In addition it is also possible to use amino-containing compounds or monomers (b3).

Preferred compounds or monomers (b) used are diols.

For effective film formation and elasticity, suitable compounds (b) containing isocyanate-reactive groups are principally diols (b1) of relatively high molecular weight, having a molecular weight of from about 500 to 5000, preferably from about 1000 to 3000, g/mol.

The diols (b1) comprise, in particular, polyesterpolyols, which are known, for example, from Ullmanns Encyklopädie der technischen Chemie, 4th edition, volume 19, pp. 62-65. It is preferred to use polyesterpolyols obtained by reacting dihydric alcohols with dibasic carboxylic acids. Instead of the free polycarboxylic acids it is also possible to use the corresponding polycarboxylic anhydrides or corresponding polycarboxylic esters with lower alcohols, or mixtures thereof, to prepare the polyesterpolyols. The polycarboxylic acids may be aliphatic, cycloaliphatic, araliphatic, aromatic or heterocyclic and may where appropriate be unsaturated and/or substituted, by halogen atoms for example. Examples thereof that may be mentioned include the following: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, alkenylsuccinic acid, fumaric acid, and dimeric fatty acids. Preference is given to dicarboxylic acids of the formula HOOC—(CH₂)_{y}—COOH, where y is a number from 1 to 20, preferably an even number from 2 to 20, examples thereof being succinic acid, adipic acid, dodecanedicarboxylic acid, and sebacic acid.

Suitable diols further include tricyclodecanedimethanol [3(4),8(9)-bis(hydroxymethyl)tricyclo[5.2.1]decane] and also Dianols (ethoxylated bisphenol A glycidyl ethers).

Examples of suitable diols include ethylene glycol, propane-1,2-diol, propane-1,3-diol, butane-1,3-diol, butane-1,4-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols, diethylene glycol, triethylene glycol, tetraethylene glycol, polyethylene glycol, dipropylene glycol, polypropylene glycol, dibutylene glycol, and polybutylene glycols. Preference is given to alcohols of the formula HO—(CH₂)ₓ—OH, where x is a number from 1 to 20, preferably an even number from 2 to 20. Examples thereof are ethylene glycol, butane-1,4-diol, hexane-1,6-diol, octane-1,8-diol, and dodecane-1,12-diol. Preference is further given to neopentyl glycol and pentane-1,5-diol. These diols may also be used as diols (b2) directly to synthesize the polyurethanes.

Also suitable, furthermore, are polycarbonatediols (b1), as may be obtained, for example, by reacting phosgene with an excess of the low molecular weight alcohols specified as synthesis components for the polyesterpolyols.

Also suitable are lactone-based polyesterdiols (b1), which are homopolymers or copolymers of lactones, preferably hydroxy-terminal adducts of lactones with suitable difunctional starter molecules. Suitable lactones include preferably those derived from compounds of the formula HO—(CH₂)_{z}—COOH, where z is a number from 1 to 20 and where one hydrogen atom of a methylene unit may also be substituted by a C₁ to C₄ alkyl radical. Examples are epsilon-caprolactone, β-propiolactone, γ-butyrolactone and/or methyl-epsilon-caprolactone, and also mixtures thereof. Examples of suitable starter components are the low molecular weight dihydric alcohols specified above as synthesis components for the polyesterpolyols. The corresponding polymers of ε-caprolactone are particularly preferred. Lower polyesterdiols or polyetherdiols may also be used as starters for preparing the lactone polymers. Instead of the polymers of lactones it is also possible to use the corresponding, chemically equivalent polycondensates of the hydroxycarboxylic acids corresponding to the lactones.

Further suitable monomers (b1) include polyetherdiols. These are obtainable in particular by polymerizing ethylene oxide, propylene oxide, butylene oxide, tetrahydrofuran, styrene oxide or epichlorohydrin with itself, in the presence of BF₃, for example, or by addition of these compounds, where appropriate as a mixture or in succession, with starting components containing reactive hydrogen atoms, such as alcohols or amines, e.g., water, ethylene glycol, propane-1,2-diol, 1,2-bis(4-hydroxyphenyl)propane or aniline. Particular preference is given to polytetrahydrofuran with a molecular weight of from 240 to 5000, in particular from 500 to 4500.

Likewise suitable are polyhydroxyolefins (b1), preferably those having 2 terminal hydroxyl groups, e.g., α,ω-dihydroxypolybutadiene, α,ω-dihydroxypolymethacrylic esters or α,ω-dihydroxypolyacrylic esters, as monomers (b1). Such compounds are known, for example, from EP-A-0 622 378. Further suitable polyols (b1) are polyacetals, polysiloxanes, and alkyd resins.

Instead of the diols (b1) it is also possible in principle to use low molecular weight isocyanate-reactive compounds, having a molecular weight of from 62 to 500, in particular 62 to 200, g/mol. It is preferred to use low molecular weight diols (b2).

Diols (b2) used are in particular short-chain alkanediols specified as synthesis components for the preparation of polyesterpolyols, preference being given to the branched and unbranched diols having 2 to 20 carbon atoms and an even number of carbon atoms, and also pentane-1,5-diol. Also suitable as diols (b2) are phenols or bisphenol A or F.

The hardness and the modulus of elasticity of the polyurethanes can be increased by using not only the diols (b1) but also the low molecular weight diols (b2) as diols (b).

The fraction of the diols (b1), based on the total amount of the diols b, is preferably from 0 to 100, in particular from 10 to 100, with particular preference from 20 to 100 mol % , and the fraction of the monomers (b2), based on the total amount of the diols (b), is from 0 to 100, in particular from 0 to 90, with particular preference from 0 to 80 mol % . With particular preference the molar ratio of the diols (b1) to the monomers (b2) is from 1:0 to 0:1, more preferably from 1:0 to 1:10, with particular preference from 1:0 to 1:5.

For components (a) and (b) it is also possible to use functionalities>2.

Examples of suitable monomers (b3) are hydrazine, hydrazine hydrate, ethylenediamine, propylenediamine, diethylenetriamine, dipropylenetriamine, isophoronediamine, 1,4-cyclohexyldiamine, and piperazine.

In minor amounts it is also possible to use monofunctional hydroxyl-containing and/or amino-containing monomers. Their fraction should not exceed 10 mol % of components (a) and (b). Furthermore, in very small fractions, the monomers used may also include ionic or nonionic hydrophilic compounds. Preferably, however, such monomers will be avoided.

Further suitable polyadducts include the reaction products of epoxides with, for example, alcohols, thiols, amines, acid anhydrides or carboxylic acids, and also combinations thereof.

Particular mention may be made here of the reaction product of epoxy resins with alcohol compounds having two OH groups or with dicarboxylic acids.

Examples of suitable epoxide compounds include mono- and polyfunctional glycidyl ethers.

In this context it is particularly preferred to use epoxide compounds with a functionality of two or three, examples being the corresponding glycidyl ethers. Particularly suitable epoxide compounds include bisphenol A diglycidyl ethers of the formula (I) 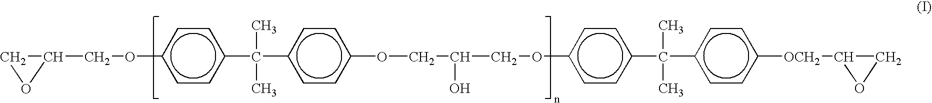
where n is 0 to 15.

The corresponding bisphenol A diglycidyl ether derivative where n=0 is sold, for example, as a commercial product under the name Epicote® 828 by Shell.

Further particularly suitable epoxide compounds include butanediol diglycidyl ether, pentaerythritol triglycidyl ether, neopentyl glycol diglycidyl ether or hexanediol diglycidyl ether. It is also possible to use water-dispersible epoxide compounds.

Considered generally, epoxide compounds which can be used include aromatic glycidyl compounds such as the bisphenols A of the formula (I) or their bromine derivatives, and also phenol novolak glycidyl ether or cresol novolak glycidyl ether, bisphenol F diglycidyl ether, glyoxal-tetraphenol tetraglycidyl ether, N,N-diglycidylaniline, p-aminophenol triglycide or else 4,4′-diaminodiphenylmethane tetraglycide.

Further suitable epoxide compounds include cycloaliphatic glycidyl compounds such as, for example, diglycidyl tetrahydrophthalate, diglycidyl hexahydrophthalate or hydrogenated bisphenol A diglycidyl ethers, or heterocyclic glycidyl compounds such as triglycidyl isocyanurate and also triglycidylbishydantoin.

As epoxide compounds it is additionally possible, furthermore, to use cycloaliphatic epoxy resins such as 3,4-epoxycyclohexylmethyl 3′,4′-epoxycyclohexanecarboxylate, bis(3,4-epoxycyclohexylmethyl) adipate or 3-(3′,4′-epoxycyclohexyl)2,4-dioxaspiro[5,5]-8,9-epoxyundecane, and also aliphatic epoxy resins such as butane-1,4-diol diglycidyl ether or polypropylene glycol-425 diglycidyl ether.

Examples of further suitable epoxides include cycloaliphatic bisepoxides, epoxidized polybutadienes formed by reacting commercial polybutadiene oils with peracids or organic acid/H₂O₂ mixtures, epoxidation products of naturally occurring fats or oils, and suitable acrylate resins containing independent oxirane groups.

Particularly suitable alcohols for the polyaddition with epoxides are the diols (b) used for the preparation of the polyurethanes.

As amines for the polyaddition with epoxides it is possible in particular to use compounds containing at least two amine functions, examples being isophoronediamine, N-(2-hydroxyethyl)-1,3-propanediamine or else 3,3′-dimethyl-4,4-diaminodicyclohexylmethane.

As polyadducts with epoxides it is additionally possible to make use in particular of compounds with two acid anhydrides or with two carboxylic acids, for example, maleic acid and maleic anhydride, azelaic acid and dodecanoic acid, or else norcaranedicarboxylic acid or dimer fatty acids or cyclohexanedicarboxylic acids.

In the case of the polyadducts with epoxides, the ratio of their constituent monomers, i.e., the epoxide compounds on the one hand and the alcohols, amines, carboxylic acids and/or acid anhydrides on the other, is situated in a range such that the ratio of epoxide functions on the one hand and epoxide-reactive functions on the other is from 0.2:1 to 5:1, in particular from 0.5:1 to 2:1, preferably from 0.8:1 to 1.2:1 and with particular preference 1:1.

The proportion of the polyadducts, based on the sum of the fractions of the polyadducts and of the free-radical addition polymers, is preferably from 1 to 99% by weight, in particular from 5 to 95% by weight, and with particular preference from 10 to 90% by weight.

The polyaddition reaction is preferably conducted at temperatures from 30 to 120° C., in particular at from 40 to 100° C. It is generally initiated by an increase in temperature. It may also be advisable to operate under superatmospheric pressure.

Suitable free-radical addition polymers are all polymers which can be obtained by free-radical addition polymerization from the corresponding free-radically polymerizable monomers. The free-radical addition polymerization is conducted in particular at temperatures from 20 to 150° C., with particular preference at temperatures from 40 to 120° C. The polymerization may also take place under superatmospheric pressure and be carried out with induction by radiation, in particular UV radiation.

Preferably at least 40% by weight, with particular preference at least 60% by weight, of the free-radical addition polymer is composed of what are termed principal monomers, selected from C₁-C₂₀ alkyl (meth)acrylates, C₃-C₂₀ cycloalkyl (meth)acrylates, vinyl esters of carboxylic acids containing up to 20 carbon atoms, vinylaromatics having up to 20 carbon atoms, ethylenically unsaturated nitriles, vinyl halides, vinyl ethers of alcohols containing 1 to 10 carbon atoms, aliphatic hydrocarbons having 2 to 8 carbon atoms and 1 or 2 double bonds, or mixtures of these monomers.

Examples include (meth)acrylic acid alkyl esters having a C₁-C₁₀ alkyl radical, such as methyl methacrylate, methyl acrylate, n-butyl acrylate, ethyl acrylate, and 2-ethylhexyl acrylate.

Also suitable in particular are mixtures of the (meth)acrylic acid alkyl esters.

Vinyl esters of carboxylic acids having 1 to 20 carbon atoms are, for example, vinyl laurate, vinyl stearate, vinyl propionate, Versatic acid vinyl esters, and vinyl acetate.

Suitable vinylaromatic compounds include vinyltoluene, α- and p-methylstyrene, α-butylstyrene, 4-n-butylstyrene, 4-n-decylstyrene and preferably styrene.

Examples of nitriles are acrylonitrile and methacrylonitrile.

The vinyl halides are ethylenically unsaturated compounds substituted by chlorine, fluorine or bromine, preferably vinyl chloride and vinylidene chloride.

Examples of vinyl ethers include vinyl methyl ether and vinyl isobutyl ether. Preference is given to vinyl ethers of alcohols containing 1 to 4 carbon atoms.

As hydrocarbons having 2 to 8 carbon atoms and two olefinic double bonds mention may be made of butadiene, isoprene and chloroprene; examples of those having one double bond include ethene and propene.

In addition to these principal monomers, the addition polymer may contain further monomers, e.g., hydroxyl-containing monomers, especially C₁-C₁₀ hydroxyalkyl (meth)acrylates, C₃-C₂₀ hydroxy(cyclo)alkyl (meth)acrylates, (meth)acrylamide, ethylenically unsaturated acids, especially carboxylic acids, such as (meth)acrylic acid or itaconic acid, and their anhydrides, dicarboxylic acids and their anhydrides or monoesters, e.g., maleic acid, fumaric acid, and maleic anhydride. Very particular preference is given to C₁-C₁₀ hydroxyalkyl (meth)acrylates.

The hybrid dispersions of the invention comprising the polyadducts and the free-radical addition polymers are preferably obtainable by conducting the polyaddition and free-radical addition polymerization in an aqueous miniemulsion whose monomer droplets have a particle size of not more than 1000 nm, preferably not more than 500 nm, in particular not more than 300 nm. With particular preference the particle sizes of the monomer droplets in the case of a miniemulsion are from 50 to 300 nm. The fine dispersion of the monomer droplets in the case of a miniemulsion is accomplished by mechanical introduction of energy in the form, for example, of strong shearing. Such shearing may take place, inter alia, by means of two opposingly directed nozzles in a mixing chamber. A further possibility is to carry out shearing using ultrasound, by means of an ultrasound rod, for example, or using a nozzle jet disperser.

In the case of a miniemulsion it is possible to add what is termed a costabilizer to the monomers, said costabilizer featuring low solubility in water and high solubility in the monomers.

In miniemulsion polymerization, the addition polymerization or polyaddition takes place in the monomer droplets themselves.

The hybrid dispersions of the invention are obtainable by emulsifying the constituent monomers of the polyadducts and free-radical addition polymers in water and conducting the polyaddition reaction and/or free-radical addition polymerization in the resulting emulsion. The aqueous emulsion is normally built with the aid of suitable emulsifiers and/or protective colloids or stabilizers. It is also possible to emulsify only some of the monomers in water and-to add the remainder later in the course of the reaction, preferably by way of the aqueous phase.

In the case of emulsion polymerization it is general practice to use ionic and/or nonionic emulsifiers and/or protective colloids or stabilizers as surface-active compounds.

An in-depth description of suitable protective colloids is given in Houben-Weyl, Methoden der organischen Chemie, volume XIV/1, Makromolekulare Stoffe, Georg-Thieme-Verlag, Stuttgart, 1961, pp. 411 to 420. Suitable emulsifiers include anionic, cationic, and nonionic emulsifiers. As accompanying surface-active substances it is preferred to use exclusively emulsifiers, whose molecular weights, unlike those of the protective colloids, are usually below 2000 g/mol. Where mixtures of surface-active substances are used the individual components must of course be compatible with one another, something which in case of doubt can be checked by means of a few preliminary tests. It is preferred to use anionic and nonionic emulsifiers as surface-active substances. Examples of common accompanying emulsifiers include ethoxylated fatty alcohols (EO units: 3 to 50, alkyl: C₈ to C₃₆), ethoxylated mono-, di-, and tri-alkylphenols (EO units: 3 to 50, alkyl: C₄ to C₉), alkali metal salts of dialkyl esters of sulfosuccinic acid, and alkali metal salts and ammonium salts of alkyl sulfates (alkyl: C₈ to C₁₂), of ethoxylated alkanols (EO units: 4 to 30, alkyl: C₁₂ to C₁₈), of ethoxylated alkylphenols (EO units: 3 to 50, alkyl: C₄ to C₉), of alkylsulfonic acids (alkyl: C₁₂ to C₁₈), and of alkylarylsulfonic acids (alkyl: C₉ to C₁₈).

Suitable emulsifiers are also given in Houben-Weyl, Methoden der organischen Chemie, volume 14/1, Makromolekulare Stoffe, Georg Thieme Verlag, Stuttgart, 1961, pages 192 to 208.

Tradenames of emulsifiers include, for example, Dowfax® 2 A1, Emulan® NP 50, Dextrol® OC 50, Emulgator 825, Emulgator 825 S, Emulan® OG, Texapon® NSO, Nekanil® 904 S, Lumiten® I-RA, Lumiten E 3065 etc.

The surface-active substance is commonly used in amounts of from 0.1 to 10% by weight, based on all the monomers to be polymerized.

Water-soluble initiators for the free-radical emulsion polymerization are, for example, ammonium salts and alkali metal salts of peroxodisulfuric acid, e.g., sodium peroxodisulfate, hydrogen peroxide or organic peroxides, e.g., tert-butyl hydroperoxide.

Particularly suitable are the systems known as reduction-oxidation (redox) initiator systems.

The redox initiator systems are composed of at least one, usually inorganic, reducing agent and one organic or inorganic oxidizing agent.

The oxidizing component comprises, for example, the initiators already mentioned above for the emulsion polymerization.

The reducing components comprise, for example, alkali metal salts of sulfurous acid, such as sodium sulfite, sodium hydrogensulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems may be used together with soluble metal compounds whose metallic component is able to exist in a plurality of valence states.

Common redox initiator systems include, for example, ascorbic acid/iron(II) sulfate/sodium peroxodisulfate, tert-butyl hydroperoxide/sodium disulfite, and tert-butyl hydroperoxide/Na hydroxymethanesulfinate. The individual components, the reducing component for example, may also be mixtures, one example being a mixture of the sodium salt of hydroxymethanesulfinic acid with sodium disulfite.

Said compounds are generally used in the form of aqueous solutions, the lower concentration being determined by the amount of water that is acceptable in the dispersion and the upper concentration by the solubility of the respective compound in water.

The concentration is generally from 0.1 to 30% by weight, preferably from 0.5 to 2.0% by weight, with particular preference from 1.0 to 10% by weight, based.on the solution.

The amount of the initiators is generally from 0.1 to 10% by weight, preferably from 0.2 to 5% by weight, based on all the monomers to be polymerized. It is also possible to use two or more different initiators for the emulsion polymerization.

The polymerization medium for the emulsion may be composed either of water alone or of mixtures of water and water-miscible liquids such as acetone. It is preferred to use just water. The hybrid dispersions can be prepared in a batch operation or else as a feed process, or else as a continuous process.

The manner in which the initiator is added to the polymerization vessel in the course of the free-radical aqueous emulsion polymerization is familiar to the skilled worker. It may either all be included in the initial charge to the polymerization vessel or else added, continuously or in stages, at the rate at which it is consumed in the course of the free-radical aqueous emulsion polymerization. Specifically this will depend, in a manner familiar to the skilled worker, both on the chemical nature of the initiator system and on the polymerization temperature. Preferably, one portion is included in the initial charge and the remainder is supplied to the polymerization zone at the rate at which it is consumed.

The process, likewise of the invention, for preparing the hybrid dispersions of the invention, comprises first emulsifying the constituent monomers of the polyadducts and the free-radical addition polymers in water and then conducting the polyaddition to prepare the polyadducts and the free-radical addition polymerization to prepare the free-radical addition polymers, the respective monomers being emulsified in water before 40% of the monomers of which the polyadducts are composed have reacted to form such polyadducts.

The process of the invention can be carried out by conducting the polyaddition and the free-radical addition polymerization at the same time. A further possibility, accomplished for example by raising the temperature, is to conduct the polyaddition first and then, by addition of initiators, for example, to run the free-radical addition polymerization. Conversely it is likewise possible first to conduct the free-radical addition polymerization and thereafter the polyaddition. Both the polyaddition and the free-radical addition polymerization take place with retention of the particle size from the emulsifying step.

Both reactions, i.e., the polyaddition and the free-radical addition polymerization, may take place alongside one another without disruption, so giving two polymers independent of one another. Through an appropriate choice of the monomers employed, however, it is also possible to prepare the corresponding copolymers. Furthermore, by dint of suitable reaction conditions, graft copolymers may also be formed. If, in addition, use is made of polyfunctional monomers, then the products include semiinterpenetrating networks or crosslinked structures.

Suitable reactors for conducting the process of the invention for preparing the hybrid dispersions include the apparatus customary in polymerization art, preference being given to the use of stirred tanks especially when effective heat removal is important.

The hybrid dispersions of the invention are suitable in particular as binders for the coating compositions or impregnating compositions, e.g., for adhesives, varnishes, paints or paper coating slips, or as binders for fiber webs; in other words, anywhere where crosslinking and an increase in internal strength (cohesion) are desired.

Depending on the intended use, the aqueous dispersion may comprise additives such as thickeners, leveling assistants, pigments or fillers, fungicides, light stabilizers, wetting agents, rheological aids, defoamers, tack additives or corrosion protection additives. These additives may also be present in the monomer droplets, directly.

When used as adhesives, the dispersions may include specific auxiliaries and additaments common in adhesive technology, as well as the additives referred to above. Said auxiliaries and additaments include, for example, thickeners, plasticizers or else tackifying resins such as, for example, natural resins or modified resins such as rosin esters or synthetic resins such as phthalate resins.

The hybrid dispersions of the invention are distinguished by a particle size distribution which is not too broad, and may include a very large number of different adducts and free-radical addition polymers. Surprisingly it has also been found that, inter alia, very finely divided polyacrylates and polystyrenes may also be present together with high fractions of polyurethanes in the hybrid dispersions of the invention. The hybrid dispersions are obtainable by a relatively simple process which is likewise part of the invention.

### EXAMPLES

### Example 1

A mixture of 1.578 g of isophorone diisocyanate, 1.429 g of dodecanediol, 3 g of styrene and 250 mg of hexadecane was added to 24 g of water containing 180 mg of sodium dodecyl sulfate. The mixture was mixed for an hour at the highest magnetic stirrer setting. An ultrasound rod (Branson Sonifier W450, 90% amplitude for 2 minutes) was used to prepare the stable miniemulsion. The miniemulsion was heated to 60° C. After 4 hours, 60 mg of potassium peroxodisulfate were added to the system and the temperature was raised to 72° C. in order to initiate the free-radical addition polymerization. Complete monomer conversion is achieved after 3 hours. The particle size is 92 nm. Investigation by infrared spectroscopy shows the conversion of the isocyanate groups, while gravimetry demonstrates that the styrene has been converted. In the GPC, two separate peaks are found. By means of transmission electron microscopy, a homogeneous particle morphology is detected.

### Example 2

Like Example 1 but using polytetrahydrofuran 1000 instead of dodecanediol. The particle size is 101 nm.

### Example 3

Like Example 1 but using butyl acrylate instead of styrene. The particle size is 98 nm.

### Example 4

A mixture of 1.57 g of isophorone diisocyanate (IPDI), 1.3 g of dodecanediol, 185 mg of hydroxybutyl acrylate, 3 g of butyl acrylate and 250 mg of hexadecane was added to 24 g of water containing 180 mg of sodium dodecyl sulfate. The mixture was mixed for an hour at the highest magnetic stirrer setting. An ultrasound rod (Branson Sonifier W450, 90% amplitude for 2 minutes) was used to prepare the stable miniemulsion. The miniemulsion was heated to 60° C. After 4 hours, 60 mg of potassium peroxodisulfate were added to the system and the temperature was raised to 72° C. in order to initiate the free-radical addition polymerization. Complete monomer conversion is achieved after 3 hours. The particle size is 103 nm. Investigation by infrared spectroscopy shows the conversion of the isocyanate groups, while gravimetry demonstrates that the acrylates have been converted. The resulting polymer is insoluble and only swells in chloroform or DMF.

### Example 5

Like Example 4 but the monomer mixture is changed in order to achieve higher levels of crosslinking.

| | | Hydroxybutyl | |
|---|---|---|---|
| IPDI | Dodecanediol | acrylate | Particle size |
| 1.57 g | 1.30 g | 185 mg | 103 nm |
| 1.57 g | 1.19 g | 340 mg | 93 nm |
| 1.57 g | 0.95 g | 680 mg | 110 nm |

1. A hybrid dispersion comprising polyadducts and free-radical addition polymers, obtainable by first emulsifying the constituent monomers of said polyadducts and polymers in water and then conducting the polyaddition to prepare the polyadducts and the free-radical addition polymerization to prepare the polymers, the respective monomers being emulsified in water before 40% of the monomers of which the polyadducts are composed have reacted to form such polyadducts.

2. The hybrid dispersion as claimed in claim 1, obtainable by conducting the polyaddition and the free-radical addition polymerization in an aqueous miniemulsion whose monomer droplets have a monomer particle size of not more than 1000 nm.

3. The hybrid dispersion as claimed in claim 1, obtainable by emulsifying the respective monomers in water before 20% of the monomers of which the polyadducts are composed have reacted to form such polyadducts.

4. The hybrid dispersion as claimed in claim 1, obtainable by emulsifying the respective monomers in water before 5% of the monomers of which the polyadducts are composed have reacted to form such polyadducts.

5. The hybrid dispersion as claimed in claim 1, comprising polyurethanes and polyurethaneureas as polyadducts.

6. The hybrid dispersion as claimed in claim 1, comprising polyadducts formed by reaction of epoxide groups with alcohols, acids, amines or anhydrides.

7. The hybrid dispersion as claimed in claim 1, comprising free-radical addition polymers composed in total of at least 40% by weight of principal monomers selected from C₁ to C₂₀ alkyl (meth)acrylates, C₃ to C₂₀ cycloalkyl (meth)acrylates, vinylaromatics having up to 20 carbon atoms, vinyl esters of carboxylic acids having 1 to 20 carbon atoms, ethylenically unsaturated nitrites, vinyl ethers of alcohols containing 1 to 10 carbon atoms, vinyl halides, nonaromatic hydrocarbons having 2 to 8 carbon atoms and one or two conjugated double bonds, and mixtures of these monomers.

8. The hybrid dispersion as claimed in claim 1, the proportion of the polyadducts based on the sum of the fractions of the polyadducts and of the free-radical addition polymers being from 1 to 99% by weight.

9. A process for preparing a hybrid dispersion comprising polyadducts and free-radical addition polymers, which comprises first emulsifying the constituent monomers of said polyadducts and polymers in water and then conducting the polyaddition to prepare the polyadducts and the free-radical addition polymerization to prepare the polymers, the respective monomers being emulsified in water before 40% of the monomers of which the polyadducts are composed have reacted to form such polyadducts.

10. The process as claimed in claim 9, wherein the polyaddition and the free-radical addition polymerization are conducted at the same time.

11. The process as claimed in claim 9, wherein first the polyaddition and then the free-radical addition polymerization is conducted.

12. The process as claimed in claim 9, wherein first the free-radical addition polymerization and then the polyaddition is conducted.

13. The process as claimed in claim 9, conducted in a miniemulsion generated by means of ultrasound or by means of a nozzle jet emulsifier.

14. The process as claimed in claim 9, wherein the free-radical addition polymerization is conducted at temperatures of from 20 to 150° C.

15. The process as claimed in claim 9, wherein the polyaddition is conducted at temperatures from 30 to 120° C.

16. The process as claimed in claim 9, wherein the free-radical addition polymerization or the polyaddition is performed under superatmospheric pressure.

17. The process as claimed in claim 9, wherein the addition polymerization is conducted with induction by radiation.

18. A binder for coating compositions or impregnating compositions comprising the hybrid dispersion as claimed in claim 1.

19. A binder in adhesives, varnishes, paints, paper coating slips or fiber webs comprising the hybrid dispersion as claimed in claim 1.

20. A method for binding a material comprising utilizing the hybrid dispersion as claimed in claim 1 as a binder.

21. The method for binding a material as claimed in claim 20 wherein said material is at least one selected from the group consisting of a coating composition, an impregnating composition, an adhesive, a varnish, a paint, a paper coating slip and a fiber web.
